(19) United States
(12) Patent Application Publication
(10) Pub. No.: US 2015/0078208 A1
(43) Pub. Date: Mar. 19, 2015

(54) System and Method for Maintaining Privacy Applied to Communications Caused by an Emergency

(71) Applicant: BlackBerry Limited, Waterloo (CA)

(72) Inventors: Jan Hendrik Lucas Bakker, Ft. Worth, TX (US); Adrian Buckley, Tracy, CA (US)

(21) Appl. No.: 14/487,231

(22) Filed: Sep. 16, 2014

Related U.S. Application Data
(60) Provisional application No. 61/878,539, filed on Sep. 16, 2013.

(51) Int. Cl. H04L 29/06; H04M 11/04; H04W 4/22

(52) U.S. Cl. CPC H04L 63/0407; H04W 4/22; H04M 11/04; H04L 65/1006; H04M 2242/04
USPC 370/259

(57) ABSTRACT

A User Equipment (UE) and a method operable at the UE are disclosed. The method includes sending a first SIP message to a network, the first SIP message requesting a first service comprising at least privacy; responsive to sending the first SIP message, receiving at the UE a SIP response message, the SIP response message including a Contact header field with an indicator as a value, the indicator based on the first service; and sending a second SIP message with the indicator, the second SIP message requesting a second service.

### PRIORITY UNDER 35 U.S.C. §119(e) & 37 C.F.R. §1.78

This non-provisional patent application claims priority based upon the following prior U.S. provisional patent application: “SYSTEM AND METHOD FOR MAINTAINING PRIVACY APPLIED TO COMMUNICATIONS CAUSED BY AN EMERGENCY” Application No.: 61/878,539, filed Sep. 16, 2013, in the name(s) of Jan H. L. Bakker and Adrian Buckley; which is hereby incorporated by reference.

### FIELD OF THE DISCLOSURE

The present patent disclosure generally relates to methods and devices for allowing privacy to be addressed during an emergency call. More particularly, and not by way of any limitation, the present patent disclosure is directed to communication regarding privacy between a packet-switched (PS) network node and a user equipment (UE) when the PS network is unable to handle the emergency request as sent.

### BACKGROUND

Historically, calls to emergency telephone numbers, such as ‘911’ in North America, ‘112’ in most of Europe and ‘110’ in Japan, have received special handling to route the calls to a Public Safety Access Point (PSAP). In order to ensure that response to emergency situations is timely, these calls—traditionally handled by the circuit-switched (CS) networks, but now also being handled in packet-switched (PS) networks—have been delivered to the PSAP with location information and identity of the calling party. Some countries, like Japan, allow services such as privacy to be requested during an emergency call, e.g., to allow a crime to be reported to the police anonymously. A number of issues can arise in connection with these changes, but currently no mechanisms exist for communication between the networks and UE devices regarding privacy in emergency calls when the emergency call is initiated over PS networks.

### BRIEF DESCRIPTION OF THE DRAWINGS

A more complete understanding of the embodiments of the present patent disclosure may be had by reference to the following Detailed Description when taken in conjunction with the accompanying drawings wherein:

FIG. 1 depicts an exemplary distributed network environment wherein one or more embodiments of the present patent disclosure may be practiced;

FIG. 2 depicts an exchange of messages between a UE and one or more network nodes according to an embodiment of the present disclosure;

FIG. 3 depicts an exchange of messages between a UE and one or more network nodes according to an embodiment of the present disclosure;

FIG. 4 depicts an exchange of messages between a UE and one or more network nodes according to an embodiment of the present disclosure;

FIG. 5 depicts an exchange of messages between a UE and one or more network nodes according to an embodiment of the present disclosure;

FIGS. 6A-6C depict various exchanges of messages between a UE and one or more network nodes in order to provision the UE according to an embodiment of the present disclosure; and

FIG. 7 depicts a block diagram of a User Equipment (UE) according to an embodiment of the present patent disclosure.

### DETAILED DESCRIPTION OF THE DRAWINGS

The present patent disclosure is broadly directed to methods and devices that provide communication between a network and a user device when a request is received for both privacy service and emergency service. Related thereto, also described are devices capable of acting on this communication.

In one aspect, an embodiment is directed to a method operable at a User Equipment (UE) comprising sending a first SIP message to a network, the first SIP message requesting a first service comprising at least privacy; responsive to sending the first SIP message, receiving at the UE a SIP response message, the SIP response message including a Contact header field with an indicator as a value, the indicator based on the service; and sending a second SIP message with the indicator, the second SIP message requesting a second service. A SIP header field, including the Contact header field, typically consists of a name and a value.

In one aspect, an embodiment is directed to a method operable at a network node. The method includes receiving a SIP message from a User Equipment (UE), the SIP message requesting a service; and responsive to the receiving, sending a SIP response message, the SIP response message including a Contact header field with an indicator as a value, the indicator based on the service, the indicator comprising an indication of privacy and “sos”.

In one aspect, an embodiment is directed to a User Equipment (UE) containing a processor operably connected to a memory and to a communications subsystem. Instructions stored in the UE perform the following: sending a first SIP message to a network, the first SIP message requesting a first service comprising at least privacy; responsive to sending the first SIP message, receiving at the UE a SIP response message, the SIP response message including a Contact header field with an indicator as a value, the indicator based on the service; and sending a second SIP message with the indicator, the second SIP message requesting a second service.

For the purpose of this application, the following understandings are noted:
A service can be but is not limited to any of the following:
   Initiated by a request for a dialog, a stand-alone transaction, or a non-emergency transaction;
   A non emergency service;
   An emergency service; or
   Identified by an address, where the address could be but is not limited to URN, digits, alphanumeric string etc.
A non-emergency service maybe referred to in this application as non-emergency call, non-emergency procedure, non-emergency registration etc.
A SIP request for a dialog is part of a transaction.

The transaction ends at the User Agent Client (UAC) after acknowledging a final response by transmitting a SIP ACK request. A User Agent Server (UAS) may have transmitted the final response. If the final response is a SIP 200 OK, the dialog is created. Further SIP request messages may be part of the same dialog. Each SIP request message is part of its own transaction. An emergency transaction is a transaction initiated by a SIP request containing an emergency identifier or emergency address. A non-emergency transaction is initiated by a request where the UAC or the UAS does not detect that the request contains an emergency identifier or emergency address.
An emergency SIP request contains an emergency identifier or emergency address. The User Agent Client (UAC) need not detect that the identifier or address is an emergency identifier or emergency address.
The dialog requested by an emergency SIP request is typically established between a PSAP acting as a User Agent Server (UAS) and a UE acting as the UAC. The PSAP coordinates the services requested by the user of the UE.
An address can also be an indicator.
A first service can be coordinated by a PSAP or an emergency centre. A second service can be coordinated by a PSAP or an emergency centre. The first service can be identified by a first address, and the second service can be identified by a second address. The first address can go in a first Request Uniform Resource Identifier (URI) field. The second address can go in a second Request URI field.

In both the CS and PS domains, a UE performs a first set of procedures to request a non-emergency call or session and a second set of procedures to request an emergency call or emergency session. In a CS network, the UE sends a SETUP message to request a call. This SETUP message contains, among other information, the digits that have been dialled or otherwise received. When a UE requests emergency services on the CS network, the UE does so by sending an EMERGENCY SETUP message. The EMERGENCY SETUP message format does not allow for dialled digits, such as the emergency numbers mentioned earlier, but contains bits indicative of the type of the emergency service needed, such as police, fire, etc. Additionally, there is no means by which a user can designate privacy when making an emergency call in a CS network. In Japan, where privacy in an emergency call is allowed, a user can enter specific digits that specify both emergency and privacy, but the emergency call will be sent using non-emergency procedures. Once the call reaches the Mobile Service Center (MSC), the call will be treated as an emergency call in routing the call to the PSAP.

In the PS domain, amongst other types of messages, SIP messages are transmitted between network nodes. SIP messages are in text and have one or more lines. A SIP message can be a SIP request message or a SIP response message. A UAC transmits a SIP request and a UAS receives a SIP request. A UAC may receive a SIP response and a UAS may transmit a SIP response in response to receiving a SIP request transmitted by the UAC. The first line of a text-encoded request message is called Request-Line and identifies that the message is a request using a specific method, e.g. an INVITE message. The first line of a SIP response message is called a Status-Line and provides a Status-Code, which is commonly listed as 2xx, 3xx, 4xx, 5xx, or 6xx. A SIP 380 message, for example, is a redirection message. SIP messages can have header fields following the first line, e.g.:
Contact: <sip:user2@192.0.2.4>
Content-Type: application/sdp
Content-Length: 131

These are just a few of the possible header fields. The Contact header field contains a SIP or SIPS Uniform Resource Identifier (URI) that can be used to contact a specific User Agent (UA) for subsequent requests. The URI contains a username and a fully qualified domain name (FQDN) and may also have an IP address. The Content-Type header field contains a description of a message body (the message body is not shown). A message body is optional and is placed after the header fields that followed the first line. Further header fields may be included in the message body itself, e.g. when the message body contains additional message bodies. The Content-Length header field is an octet (byte) count of the message body.

In SIP a UE can transmit a first initial request for a dialog, or a standalone transaction, or an unknown method. Messages that have an unknown method name, but are otherwise correctly formatted, are considered unknown methods. Typically, the network receives an unknown method when the UE is enhanced to support new SIP methods but the network isn't. In the case that the message with the unknown method name includes a URI indicative of an emergency identifier, e.g. “urn:service:sos.police”, the network should forward the request to the PSAP, if it can. Additionally, in case the UE has an application that is enhanced to request transmission by the US of SIP request messages with method names the UE doesn't recognise, the UE may also consider the request a request with an unknown method.

In the PS domain, bearers with specific characteristics to support an emergency call are set aside for use in emergency situations and are requested from the network when the UE requests a packet data network (PDN) connection suitable for emergency services. When the PDN connection suitable for emergency services is established, the UE performs an emergency registration using a bearer part of the DN connection suitable for emergency services. In non-emergency situations in the PS domain, the UE performs a non-emergency registration, hereinafter referred to as a registration, and need not receive the higher priority that is given to requests for emergency services. For example, when congestion occurs, the network can bar classes of calls or require the UE to use a back-off timer. The network can also reject a request for service from a UE that is trying to access a forbidden cell or that has insufficient credentials. A UE that detects an emergency can ignore back-off timers, Call Barring, forbidden cells and the fact that the UE has insufficient credentials to request “normal” services or “non-emergency” services. The network may accept a request from a UE that has insufficient credentials for normal service or non-emergency service, if the request includes an emergency indicator or if the request is for emergency services. A request for emergency service in a PS network can include a request for privacy, e.g., a SIP request can include both a Privacy header field set to a suitable value and a Request-URI set to an emergency identifier set to any of the following:
urn:service:sos;
urn:service:sos.police;
urn:service:sos.ambulance;
urn:service:sos.fire;
urn:service:sos.marine;
urn:service:sos.mountain.

A UE is said to detect a request for emergency services if the UE recognizes an indication that an emergency service request should be made, e.g. recognizes that the input received, such as digits, alphanumeric string, Uniform Resource Name (URN), etc. input by a user or selected from a menu, are appropriate for an emergency service. If, however, the UE is taken into a region for which the UE does not have appropriate emergency information provisioned or provided by the network, the UE may fail to recognize the input as a request for emergency services and may fail to perform emergency procedures. This is referred to as a non-UE detectable emergency request. It will be understood that a request for emergency service is also a request for priority or preferential treatment in the network. The network may apply preferential treatment to a request for priority or a request for preferential treatment. Some examples of “preferential treatment” are 1) terminating a call in progress in order to free up resources, 2) placing the request at the head of any message processing queue, 3) bypassing authorization checks or ignoring authorization check failure.

In most jurisdictions, privacy has not been allowed in requests for emergency services. Japan, however, allows a user to request emergency services and maintain privacy, e.g., to report a crime anonymously. In Japan, digit string 184 invokes privacy for a call and prevents the caller ID from being presented to the called party; for a user whose subscription withholds caller ID by default, the digit string 186 will override the default setting and provide the caller ID to the called party. Additionally, Japan allows specific digit strings for different emergency services, e.g., 110 for police, 118 for maritime emergencies, 119 for ambulance and fire brigade and 170 for earthquake assistance. Thus a user in Japan can enter the digit string 184110 to request police services but preserve privacy. Issues that can arise when a request for privacy and emergency service is received in the PS domain and must be rejected or redirected are addressed herein.

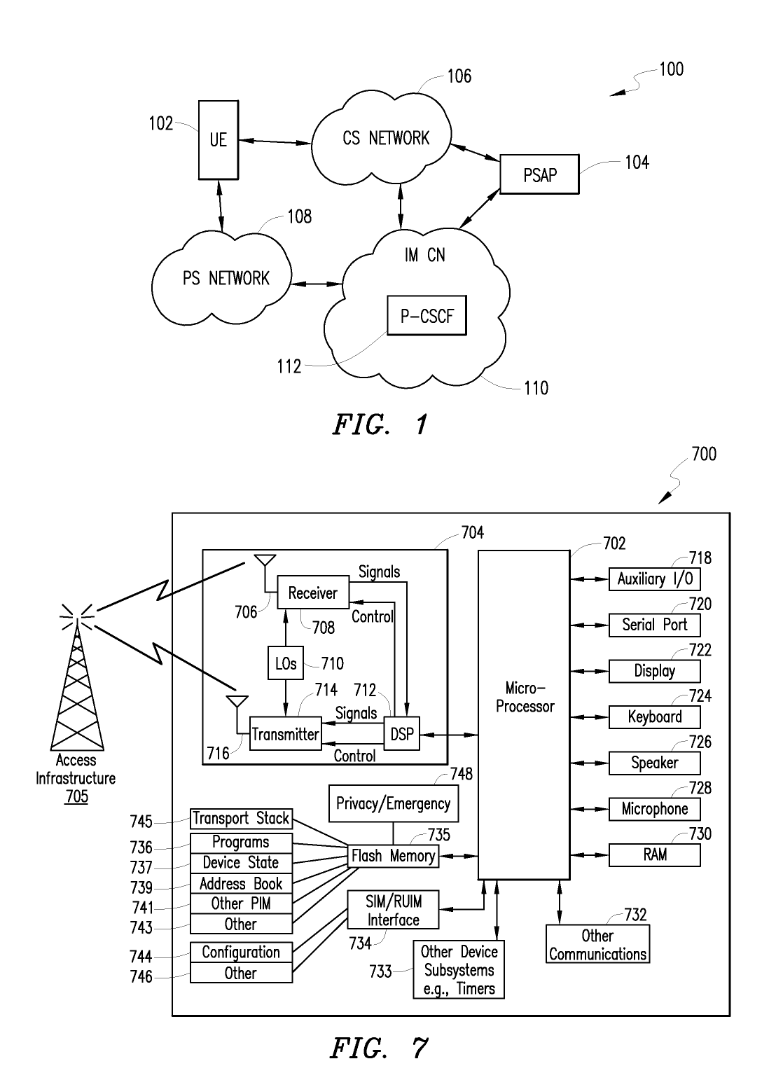

FIG. 1 illustrates an environment 100 according to an embodiment of the disclosure in which UE 102 is able to contact PSAP 104 using either CS network 106 or PS network 108. Selecting the PS domain for an emergency request includes selecting the IP Multimedia (IM) Core Network (CN) subsystem 110 (also referred to as IMS) and using Session Initiation Protocol (SIP) and the associated Session Description Protocol (SDP) for the request. As used herein, a UE can refer to mobile devices such as mobile telephones, personal digital assistants, handheld or laptop computers, tablets, and similar devices that have telecommunications capabilities. Such a UE can consist of a wireless device and its associated Universal Integrated Circuit Card (UICC) that includes a Subscriber Identity Module (SIM) application, a Universal Subscriber Identity Module (USIM) application, or a Removable User Identity Module (R-UIM) application or might consist of the device itself without such a card.

When UE 102 makes an emergency request in the PS domain, e.g., sends a SIP INVITE to PSAP 104 via PS network 108 and IM CN 110, the request is received at a network node e.g. Proxy Call Session Control Function (P-CSCF) 112 in IM CN 110. For emergency requests that the network can handle, the request is forwarded to an appropriate Public Safety Access Point (PSAP) 104 near the requesting UE 102. Sometimes P-CSCF 112 may not be able to handle emergency requests for the region from which the request originates or may have restrictions on the type of emergency requests that can be placed; the request may originate in an access network that does not support emergency services or the UE may not have used appropriate procedures. For example, although Japan allows privacy to be indicated in an emergency request, many other jurisdictions do not allow privacy to be applied to emergency requests and such a request will not be accepted.

If P-CSCF 112 has reason to reject the request, e.g., the emergency request indicates that privacy is requested, but the current jurisdiction does not allow privacy during emergency requests, P-CSCF 112 sends a response, one example being a redirection message, e.g., a SIP 380 message, to UE 102. This message must provide information to allow UE 102 to correct the issue causing the redirection. For example, since a UE can request emergency services even when the UE does not detect the emergency, the message notes that the original request was a request for emergency services and can include information, e.g., that the PS domain offers emergency services after the UE first performs an emergency registration with the PS domain if the UE did not detect the emergency status previously. On receiving the response message e.g. redirection message or rejection message, the UE performs domain selection, and can select either the CS domain or the PS domain for a next emergency request.

In some cases, UE 102 might not be aware that the original emergency request indicated a request for privacy. For example, a UE manufactured for use in North America might be programmed to recognize that a call to 911 is an emergency request. If such a UE is taken to Japan, a user may know to use the number 184110 to designate both privacy (184) and an emergency request (110), but the UE does not recognize either that the request is an emergency request or that the request includes a request for privacy. If UE 104 has not recognized that the request is an emergency request, the UE may fail to provide relevant information to the PSAP or may make the call as a regular call, in which case the call can be blocked, if the network is overloaded, or otherwise fail to receive the priority generally given to an emergency call. If the UE fails to detect that privacy was requested in the initial request and the request is redirected, the UE may fail to appropriately handle the following request.

The present disclosure provides for indicating to a UE that an IMS emergency request was also a request for privacy by including in a SIP response message to the UE, e.g., a SIP 380 message, a privacy indicator that indicates that the network detected a request for privacy in the SIP request. For purposes of the application, a request for privacy can include a designation that presentation of a public user identity associated with the UE, e.g., a Calling line Identity (CLI), should be prevented or else that prevention of presentation of a public user identity should be overridden. The request for privacy can also include a designation that presentation of the location of the UE should be prevented or that prevention of presentation of the location of the UE should be overridden. The privacy indicator can be included in a Response message, e.g. a SIP 380 message sent to the UE in response to an initial SIP request for a dialog or standalone transaction, or unknown method (e.g., a SIP INVITE request) that the UE sends in attempting to set up an emergency request. Hereinafter, the term SIP message can refer to a SIP request or a SIP response. A Proxy Call Session Control Function (P-CSCF) or an application server or other network node that is delegated to receive requests for emergency service can send a SIP message that includes the privacy indicator. For purposes of this patent application, it will be understood that references to P-CSCF 112 are not limited to this specific network node, but can encompass other network nodes that are able to perform the disclosed functionality of receiving a SIP request for emergency services and privacy and sending a redirection or other response message. After receiving the privacy indicator in a SIP message, UE 102 can include the privacy indicator in a further SIP message, e.g. a second SIP request, if the network to which the UE is redirected is enabled to provide privacy, as will be discussed in greater detail below.

At the P-CSCF

When a P-CSCF receives an indication that a UE requests emergency service, the P-CSCF can determine to send a response that is a redirection message, i.e., a SIP 380 message. The P-CSCF can make this determination, for example, if this P-CSCF is not able to handle emergency requests or is not able to handle the present emergency request for any reason. In the disclosed embodiment, a P-CSCF according to an embodiment of the disclosure can detect an indication in a request for emergency service that a) presentation of public user identifiers to the PSAP is either prevented or the prevention of presentation is overridden or b) presentation of location information to the PSAP is either prevented or prevention of presentation is overridden. These indicators can be detected, for example, in the Request-URI or the Privacy header field of the initial request. In one example, the Request-URI contains digits, e.g. entered by the user that can indicate emergency and/or privacy, such as tel:184110 in Japan, which requests both privacy and the police. In another example, the initial SIP request contains a Privacy header field that either requests privacy or overrides a standing privacy request. When the P-CSCF detects an emergency indicator, the P-CSCF will include in the SIP response message, e.g. the SIP 380 message, a Contact header field with an emergency service URN, i.e. a service URN with a top-level service type of “sos” and including any sub-service type deduced from the request. When the P-CSCF detects an indication that either privacy is requested or privacy is overridden, the P-CSCF will include in the SIP response message a privacy indicator with an appropriate setting. Lack of a privacy indicator in the SIP response message when the initial request has requested privacy can indicate that the network does not support privacy in emergency requests and/or that the network is a legacy network that does not recognize privacy in emergency requests. In at least one embodiment, the P-CSCF will also include in the 380 message an XML body, including the <ims-3gpp>element, including a version attribute, with the <alternative-service> child element with the <type> child element set to “emergency”. In at least one embodiment, the P-CSCF also includes in the 380 message an XML body, including the <action> child element of the <alternative-service> child element of the <ims-3gpp> element, set to “emergency-registration”.

As will be discussed in greater detail with reference to the UE's choice of domain, in at least one embodiment a P-CSCF, such as P-CSCF 112, can also include a string of digits or characters or a URI for use by the UE. These digits, characters or URI can include digits, characters or URI that have been received in the initial request. In at least one embodiment the P-CSCF will provide the necessary digits for use in the CS domain to request privacy and/or emergency service. In at least one embodiment, one or more strings of digits or characters are included in the contact header field's URN. Examples of a string of digits provided in a URI include the following:

tel:110;phone-context=sos.gprs

tel:110;phone-context=sos.3gpp

tel:110;phone-context=sos.3gppnetwork.org

tel:110;phone-context=sos.pub.3gppnetwork.org

tel:110;phone-context=sos.mnc<MNC>.mcc<MCC>.3gppnetwork.org

tel:110;phone-context=sos.mnc<MNC>.mcc<MCC>.pub.3gppnetwork.org

where “<MNC>” is replaced with a VPLMN's or HPLMN's MNC and “<MCC>” is replaced with a VPLMN's or HPLMN's MCC.

At the UE

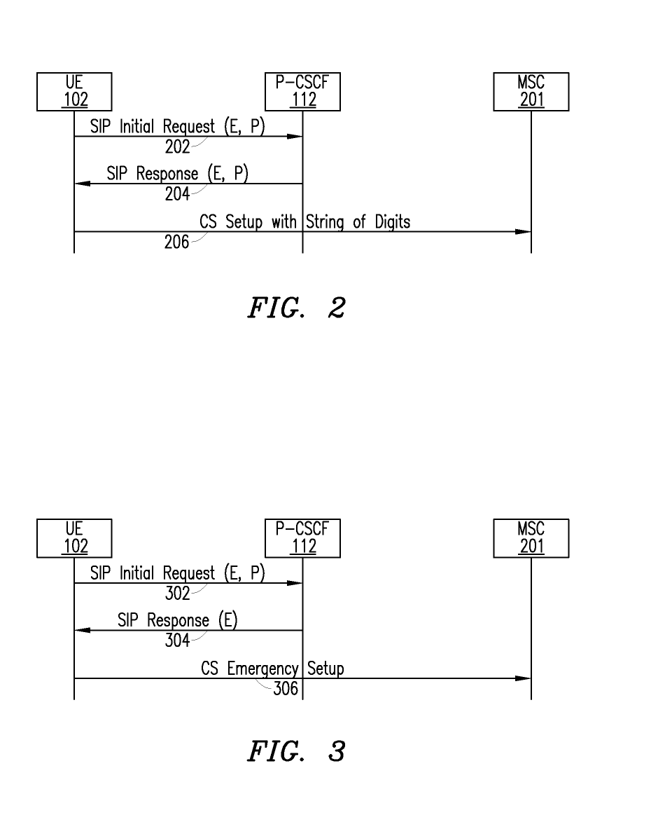

When UE 102 receives a SIP response message that rejects or redirects, e.g. SIP 380 message from P-CSCF 112, UE 102 then makes a determination which domain to use for a new emergency request, the CS domain or the PS domain. Depending on the information received and the domain selected, the new emergency request can take four forms, as will be generally explained with reference to FIGS. 2-5. First we will look at those situations in which UE 102 selects the CS domain after receiving a SIP response message, e.g. SIP 380 message from P-CSCF 112.

FIG. 2 illustrates a scenario in which the jurisdiction where UE 102 is located allows privacy in an emergency request and the network is able to recognize and allow an emergency request which requests privacy, e.g., Japan. In Japan, for example, a user enters the digits 184110 to request emergency and privacy; the UE sends a SIP initial request 202 with the URI set to TEL:184110 (shown in the figures as (E,P) for emergency and privacy). The UE may or may not recognize that the digits received, e.g. digits entered by the user, and sent by the UE are for emergency and privacy, but the network recognizes these facts. P-CSCF 112 sends SIP response message 204, e.g. a SIP 380 message, which includes both an emergency indicator and a privacy indicator (E,P). On receipt of response message 204, UE 102 selects the CS domain. As noted earlier, the set-up message for an emergency in the CS domain, which will receive priority from the network, does not allow privacy to be specified. In order to request privacy, UE 102 sends a SETUP message containing a string of digits, e.g. 184110, to the CS network in message 206. Although the call is not sent as an emergency call, the network node, e.g. MSC 201, will recognize both the emergency and privacy indicators and route the call accordingly.

FIG. 3 illustrates the same request for emergency service and privacy in a jurisdiction that does not allow privacy to be applied to emergency calls. In this scenario, a user requests emergency service with privacy and the UE sends a SIP initial request 302 requesting emergency service with privacy (E,P). P-CSCF 112 sends SIP response message 304, e.g., a SIP 380 message, which includes an emergency indicator (E), but since privacy is not allowed in this jurisdiction, P-CSCF 112 does not indicate privacy. UE 102 selects the CS domain and because SIP response message 304, indicates emergency, but not privacy, UE 102 sends an EMERGENCY SETUP 306 message, which is received, e.g. by MSC 201. In at least one embodiment, if UE 102 did not detect the original emergency but the SIP response message indicates an emergency type and subtype, e.g., ‘police’, then the UE can perform CS domain emergency call procedures, i.e. transmit an EMERGENCY SETUP message 306 indicating emergency services from the police in an included Service category information element. Similarly, if the sub-service type set to “fire”, or “ambulance”, the EMERGENCY SETUP 306 can indicate “Fire Brigade” or “Ambulance” in the Service category information element, respectively. Other mappings from the URN with a top-level service type of “sos” and a sub-service type to a Service category information element value exist. 3GPP TS 22.101 contains a list of emergency service types that can be indicated in CS: a) Police, b) Ambulance, c) Fire Brigade, d) Marine Guard, e) Mountain Rescue, f) Manually Initiated eCall (MIeC), and g) Automatically Initiated eCall (AIeC). U.S. Patent Publication 2009/0296688, filed Jun. 2, 2008 and having the same assignee as the present application, is incorporated by reference herein. This reference provides further embodiments for the providing of a combination of such emergency service types to a UE via the SIP 380 response's contents.

In at least one embodiment, the EMERGENCY SETUP message for CS is modified as shown below to include the called party's binary coded decimal (BCD) number:

| IEI | Information element | Type/Reference | Presence | Format | Length |
|---|---|---|---|---|---|
| | Call control | Protocol | M | V | 1/2 |
| | protocol | discriminator | | | |
| | discriminator | 10.2 | | | |
| | Transaction | Transaction | M | V | 1/2 |
| | identifier | identifier 10.3.2 | | | |
| | Emergency setup | Message type | M | V | 1 |
| | message type | 10.4 | | | |
| 04 | Bearer capability | Bearer capability | O | TLV | 3-11 |
| | | 10.5.4.5 | | | |
| 2D | Stream Identifier | Stream Identifier | O | TLV | 3 |
| | | 10.5.4.28 | | | |
| 40 | Supported Codecs | Supported Codec | O | TLV | 5-n |
| | | List 10.5.4.32 | | | |
| 2E | Emergency | Service category | O | TLV | 3 |
| | category | 10.5.4.33 | | | |
| | Called party BCD | Called party BCD | O | TLV | 3-43 |
| | number | num. 10.5.4.7 | | | |

In one embodiment, the called BCD number is included in Emergency Set-up Message 306 if an indication is included elsewhere in the message. This indication can be encoded as, but is not limited to, Extended Emergency Service Information in the Service Category and can indicate that privacy is to be withheld or the withholding overridden or that location is to be withheld or the withholding overridden. Alternatively no indication is provided and the Called Party BCD number is contained in the Emergency Set-up Message. In one embodiment, when the Service Category contains Extended Emergency Service Information, the format is as follows:

Service Category information element

| 8 | 7 | 6 | 5 | 4 | 3 | 2 | 1 | |
|---|---|---|---|---|---|---|---|---|
| | Service Category IEI | | | | | | | octet 1 |
| Length of Service Category | | | | | | | | octet 2 |
| 0 | Emergency Service Category Value | | | | | | | octet 3 |
| spare | | | | | | | | |

| | |
|---|---|
| Extended Emergency Service Information | Octet 4 |

Extended Emergency Service Information
Emergency Service Category Value (octet 4)

The meaning of the Emergency Category Value is derived from
the following settings (see 3GPP TS 22.101 [8] clause 10);

| | |
|---|---|
| Bit 1 | Calling Line Identity Withheld |
| Bit 2 | Calling Line identity Withheld Override |
| Bit 3 | Location Withheld |
| Bit 4 | Calling Line Identity Withheld override |
| Bit 5 | Dialled digits included |
| Bit 6 | is spare and set to ″0″ |
| Bit 7 | is spare and set to ″0″ |
| Bit 8 | is spare and set to ″0″ |

Mobile station may set one or more bits to ″1″
If more than one bit is set to ″1″,

the UE is indicating to the network that a number of different
functions are required.

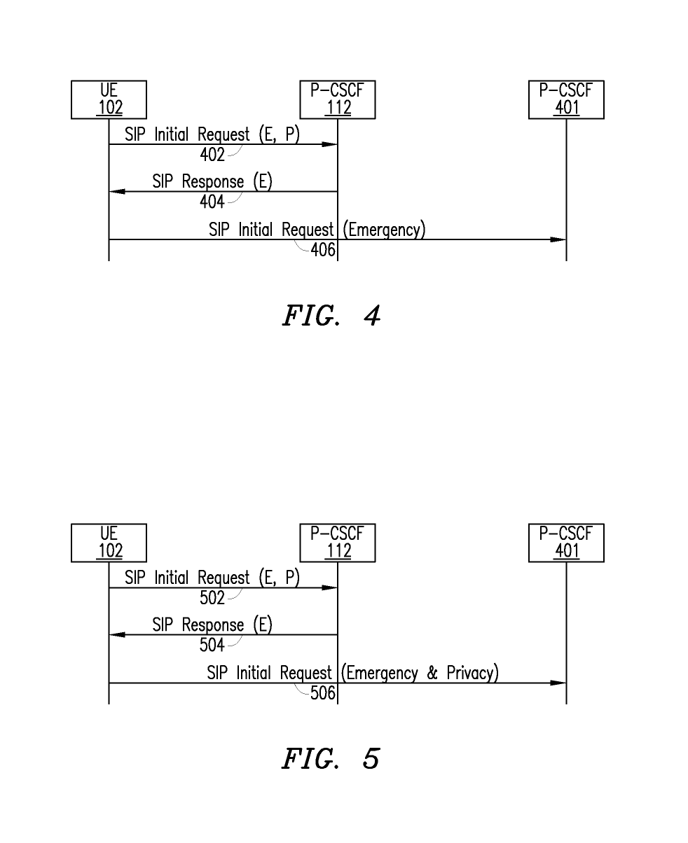

The next two figures illustrate the situation where emergency calls are allowed on the PS network, although privacy may or may not be allowed, as shown. In FIG. 4, the network does not allow privacy in emergency requests. This can be because the jurisdiction governing the network does not allow privacy to be maintained during an emergency request or because the network is a legacy network and is not configured to recognize the request for privacy. In either case, UE 102 sends a SIP request 402 that includes an emergency request and also requests privacy (E, P). If UE 102 detected that the request was for emergency services, request 402 may have been sent after UE 102 performed an emergency registration; if UE 102 did not detect that the request was for emergency service, request 402 was sent using a non-emergency registration. Whether message 402 is sent after an emergency or a non-emergency registration, P-CSCF 112 recognizes that the request is for emergency services and sends SIP response message 404, e.g., a SIP 380 message to UE 102. SIP response message 404 contains an indication that the request is an emergency request (E), but since privacy is not allowed, no privacy indicator is sent in response message 404. On receiving SIP response message 404 indicating emergency and no privacy, UE 102 sends a second SIP initial request 406, which indicates emergency, to the appropriate network entity, i.e. a network node, such as P-CSCF 401. The UE sets the Request URI of the second initial request 406 to the service URN of the Contact header field of the SIP response message 404. In at least one embodiment, P-CSCF 401 and P-CSCF 110 are the same network node, i.e., the network node was unable to handle the initial request as sent and SIP response 404 indicates that UE 102 should perform an emergency registration in order to have the request for emergency service handled. In at least one embodiment, P-CSCF 401 is reached via a second PS network than UE 102 was originally registered on, i.e. SIP response 404 redirected UE 102 to another network. As will be noted later in the present application, redirection to another PS network requires more time; in some instances UE 102 may prefer to select a CS network for a quicker response.

Finally, in FIG. 5, the network is in a jurisdiction allowing privacy in an emergency request and the network is able to recognize such a request. UE 102 sends SIP initial request 502 that is received at P-CSCF 112; as before, the request includes both an emergency request and a request for privacy (E,P). If P-CSCF 112 needs to redirect the request, P-CSCF sends a SIP response message 504, e.g., a SIP 380 message, to UE 102. SIP response message 504 contains an emergency indicator and a privacy indicator (E,P). On receiving SIP response message 504, UE 102 then sends a second SIP initial request 506 to the appropriate network node, e.g. P-CSCF 401, indicating emergency and privacy (E,P). As noted in regard to FIG. 4, UE 102 sets the Request URI of second initial request 506 to the service URN of the Contact header field of the SIP response message 504. Likewise, in at least one embodiment, P-CSCF 401 and P-CSCF 110 are the same network node, i.e., the network node was unable to handle the initial request as sent and SIP response 504 indicates that UE 102 should perform an emergency registration in order to have the request for emergency service handled. In at least one embodiment, P-CSCF 401 is reached via a second PS network, i.e. SIP response 504 redirected UE 102 to another PS network. If this occurs, then in some instances UE 102 may prefer to select a CS network for a quicker response.

In at least one embodiment, the indicator is included in a body (part) with the MIME type message/sipfrag or message/sip. Since the Privacy header field can take a number of values, the granularity of the Privacy header field can be used for indicating the type of additional procedures that needs to be performed at the UE. Non-privacy-related additional procedures may also be indicated by means of e.g. other SIP header fields. As an example of privacy-related additional procedures, the body (part) could include the following for “caller ID needs to be withheld”:

Privacy: id

or the following for “caller ID needs to be presented”:

Privacy: none

In this embodiment the UE needs to support multipart body (part) handling and the network does not include a sipfrag body (part) for other reasons in a SIP 380 response that responds to an emergency request. In this embodiment, the SIP 380 response further includes a P-Asserted-identity header field set to an address of a network node, with the Proxy-CSCF being an example of such a network node. Following the SIP 380 response in this example, when the UE selects the PS domain for the subsequent request, the UE includes content of the body (part) with the MIME type message/sipfrag or message/sip in the subsequent request and when the UE selects the CS domain for the subsequent request, the UE initiates the procedures involving the sending of a SETUP request (as opposed to the procedures involving the sending of an EMERGENCY SETUP request).

UEs that are able to support multipart body (part) MIME type, e.g. multipart/mixed, and MIME type message/sipfrag or MIME type message/sip can indicate this in the Accept header field of the first SIP request. The P-CSCF responding to the first SIP request with the SIP 380 response may only include MIME type message/sipfrag or message/sip in the SIP 380 response if the first SIP request's Accept header field indicated support for at least one of the noted MIME types.

In at least one embodiment, the indicator indicating “caller ID needs to be withheld” or “caller ID needs to be presented” are otherwise encoded within the SIP 380 response message or within the XML body included within the SIP 380 response message. Upon detecting the otherwise encoded indicator, when the UE selects the PS domain for the subsequent request, the UE includes either “Privacy:id” or “Privacy:none” in the subsequent request, depending on what the indicator indicates. When the UE consequently selects the CS domain for the subsequent request, the UE initiates the procedures involving the sending of a SETUP request, as opposed to the procedures involving the sending of an EMERGENCY SETUP request). In at least one embodiment, the indicator is included in a body (part) with a MIME type different from message/sipfrag or message/sip. However, the body (part) contains, for example for privacy-related additional procedures, the following for “caller ID needs to be withheld”:

Privacy: id

or the following for “caller ID needs to be presented”:

Privacy: none

The advantage of using a body (part) with a MIME type different from message/sipfrag or message/sip, yet having the body part contain similar information, is that the P-CSCF can use body parts with MIME type message/sipfrag or message/sip for different purposes.

In at least one embodiment, different content encoding may be used e.g. when XML encoding is used:
“<privacy value=”id“>” to indicate caller ID needs to be removed); or
“<privacy value=”none“>” to indicate caller ID needs to be provided).
   The above XML encoding or equivalent XML encoding may be detected in the MIME body of the MIME type “application/3gpp-ims+xml”.

In each of FIGS. 2-5 noted above, UE 102 sends a SIP message that requests both an emergency response and privacy, where the request for privacy can be either a request that user information and/or location information be withheld or a request that user information and/or location information that is normally withheld be provided. As noted, a number of specific issues can arise to necessitate the sending of a SIP 380 message in response:
The UE may not detect that digits indicate an emergency and thus may not have performed emergency registration;
Priority access to the network may not be provided due to not detecting the emergency; and
The UE may not detect that digits indicate a request for privacy.

In SIP, any message can include a privacy header; by using the privacy header in a SIP request sent to the network, the UE can indicate that it has recognized a request for privacy. Specific actions that UE 102 takes to indicate that the UE has detected an emergency request in the PS domain can vary. Depending on implementation, UE 102 may perform additional instructions when performing emergency procedures than when performing basic procedures. Alternatively, when performing emergency procedures, UE 102 may perform some subset of the instructions used to perform basic procedures. The SIP response message should provide enough information for UE 102 to determine both an appropriate domain (CS or PS) and appropriate procedures. In addition to providing indication of an emergency request, a SIP response message according to an embodiment of the disclosure includes a privacy indicator that can include any of the following:
An indication that a calling line identity (CLI) should be withheld;
An indication that a CLI withheld override should be sent;
An indication that location of the UE should be withheld; or
An indication that location withheld override should be sent.
   Lack of a privacy indicator in the SIP response message can indicate that the network does not recognize the request for privacy or does not support a request for privacy in an emergency request.

In addition to the privacy indicator, the SIP response message can also include an indication that one of the following should be performed:
An emergency call should be made on an alternative network or domain; or
A normal call should be made on an alternative domain setting.

Either of these indications can be accompanied by additional instructions to:
Use the digits string received in the SIP request;
Use the alphanumeric string in the SIP request;
Use a digit string provided in the current response; and
Use the alphanumeric string in the current response.

These indicators can be provided in the SIP 380 message in any of the following ways:
A new Header field value;
A feature tag;
As the body or part of the body of the message, the body part could include XML or be typed message/sip or message/sipfrag; or
An R-URI value.

Redirection within a Network

When UE 102 receives a SIP 380 response to a SIP request according to an embodiment according to the disclosure, the UE must select a domain for the next action. Table 1 below provides an example of the selection the UE can be directed to take.

TABLE 1

| Procedures | | | If CS | If PS |
|---|---|---|---|---|
| Used At UE | UE | SIP 380 | Selected, | Selected, |
| In 1^{st} | Detects | Indicates | Use These | Use These |
| Request | Privacy? | Privacy? | Procedures | Procedures |
| Emergency | Yes | Yes | Normal | Emergency + |
| | | | | Privacy |
| Emergency | Yes | No | Emergency | Emergency |
| Emergency | No | Yes | Normal | Emergency + |
| | | | | Privacy |
| Emergency | No | No | Normal or | Emergency |
| | | | Emergency* | |
| Normal | Yes | Yes | Normal | Emergency + |
| | | | | Privacy |
| Normal | Yes | No | Emergency** | Emergency** |
| Normal | No | Yes | Normal | Emergency + |
| | | | | Privacy |
| Normal | No | No | Normal or | Emergency |
| | | | Emergency* | |

Looking at Table 1, column 1 provides an indication whether or not UE 102 detected that the request was an emergency request, i.e., whether the UE used emergency or normal procedures to send the SIP request. Columns 2 and 3 illustrate whether or not the UE detected the request for privacy, e.g., by using a SIP Privacy Header or other indication of privacy, and whether or not the SIP response indicates privacy using the disclosed privacy indicator. The last two columns provide the type of procedures, normal or emergency, which could be selected by the UE when the CS or PS domain is selected.

As shown in this table, if the network is operable to accept a request for privacy in an emergency request and provides that information to the UE, then UE 102 can select the PS domain and utilize emergency protocols with privacy. This provides an optimal response, regardless of whether or not the UE was initially able to recognize that it was sending an emergency request with privacy. In at least one embodiment, the SIP response message contains a Contact header field having a service URN with a top-level service type of “sos”, indicating emergency. The UE can then set the Request-URI of the second initial request to the value of the service URN in the Contact header field of the SIP response message. This situation corresponds to the embodiment shown in FIG. 5. In at least one embodiment the privacy indicator is a Privacy header field in a SIP response and the UE can set the Privacy header field in the second initial request message.

If UE 102 selects the CS domain after receiving a redirection message that contains a privacy indicator, UE 102 can use a normal call set-up, since privacy cannot be requested in an emergency call set-up. The SIP response message may provide, for example, the digits 184110 or may include an indication that the UE use the digits previously sent in a SIP request in a normal call set-up in the CS domain. This situation corresponds to the embodiment illustrated in FIG. 2.

In those networks that do not indicate privacy in the SIP response message, a UE that selects the PS domain for the next SIP request can perform emergency procedures without a request for privacy, as illustrated in FIG. 4. A UE that selects the CS domain for the emergency call can, in many situations, select to use either normal procedures or emergency procedures, although emergency procedures are preferable because they can avoid network delays. It is notable that failure of the UE to detect privacy combined with the absence in the SIP response message of an indication that privacy was detected may mean that privacy was not requested. In such a case, not performing emergency call procedures could potentially result in a denied call attempt in situations of network overload, back-off instructions, a forbidden cell, or insufficient credentials. If the network node provides the SIP response message with a Contact header field with a URN and the Contact header field can be mapped such that an emergency set-up can be transmitted, then emergency procedures should be invoked. Such a mapping occurs when the Contact header field contains a service URN with a top-level service type of “sos”. These situations are indicated in Table 1 by *. It is notable that the SIP response message may indicate that further action needs to be taken prior to sending the second initial request. In at least one embodiment, the additional procedures are necessary when privacy was requested. In at least one embodiment, additional procedures are necessary when privacy is to be overridden.

In at least some situations, e.g., in the example shown in the sixth line of Table 1, UE 102 can conditionally perform the emergency procedures after notifying the user of the conflict in requesting both emergency and privacy, i.e., when the user accepts, acknowledges or is made aware that privacy is not applicable. This situation, indicated in the table by **, could indicate that a user who is aware of the conflict selected a normal procedure but requested both privacy and emergency, e.g., by a string of digits such as 184110. However, if the UE failed to detect privacy then a legacy network element may not indicate that privacy was detected. In the latter case, the user may not be made aware, accept, or acknowledge that privacy is not applied to an automatically initiated second request for emergency services.

Redirection to Another Network

In a second embodiment, the UE may have made the request for emergency and privacy on a PS network that is not equipped to handle emergency calls. A PS network that does not support emergency calls will not support emergency bearers, nor will it support an emergency registration. The network node that receives the emergency call or session can redirect/refer the UE to a second PS network that is able to handle emergency calls. However, because this is recognized as an emergency situation by the network, time is of the essence and re-registering to another network is time consuming. For this reason, the situation may determine whether the UE selects a network in the CS or PS domain. Table 2 illustrates both whether the UE detected the emergency and/or privacy in the original request (i.e., PRIV and EMERG), whether the redirection message indicates that emergency registration is required (E-reg Ind.) and whether a privacy indicator is included (Priv. Ind.), as well as other fields that may be provided in the SIP response message, i.e., whether the SIP response contains a string of digits/characters or an element that can be mapped to a service category information element. The procedures that the UE can execute are abbreviated as follows: ‘CSNP’=CS domain call set-up using normal procedure, ‘CSEP’=CS domain call set-up using emergency procedure, ‘PSEP’=PS domain session set-up using emergency procedure, ‘OPEP’=Other PLMN's PS domain session set-up using emergency procedure. Additionally, the suffix ‘/P’ indicates that privacy is also invoked. Because of the time element, the possible procedures are ordered, with the more preferable procedure being listed first:

TABLE 2

| | | Redirection Message contains: | | | | |
|---|---|---|---|---|---|---|
| UE detects: | | E-reg | Priv. | | | Domain |
| PRIV | EMERG | Ind. | Ind. | Digits | Maps/SC | To Use |
| y | y | y | y | y (n means | n.a. | CSNP, |
| | | | | OPEP/P) | | OPEP/P |
| y | y | y | n | y (n means | n | OPEP, |
| | | | | OPEP) | | CSNP |
| y | y | n.a. | n | n.a. | y | CSEP, |
| | | | | | | OPEP |
| y | y | n | y | y (n means | n.a. | OPEP/P, |
| | | | | OPEP/P) | | CSNP |
| y | n | y | y | y (n means | n.a. | CSNP, |
| | | | | PSEP/P) | | PSEP/P |
| y | n | n | y | y (n means | n.a. | CSNP, |
| | | | | OPEP/P) | | OPEP/P |
| y | n | n | n | n.a. | y | CSEP, |
| | | | | | | OPEP |
| y | n | y | n | n.a. | y | CSEP, |
| | | | | | | PSEP |
| y | n | n | n | y (n means | n | CSNP |
| | | | | no call) | | |
| y | n | y | n | y (n means | n | PSEP, |
| | | | | PSEP) | | CSNP |
| n | n | y | y | y (n means | n.a. | PSEP/P, |
| | | | | PSEP/P) | | CSNP |
| n | y | y | n | y (n means | n | CSNP, |
| | | | | OPEP) | | OPEP |
| n | y | n.a | n | y (n means | y | CSEP, |
| | | | | OPEP) | | OPEP |
| n | n | n.a | y | y (n means | n.a. | CSNP, |
| | | | | OPEP/P) | | OPEP/P |

Although we shall not discuss each entry into this table, an example will provide illustration of the principals involved. In line one of Table 2, UE 102 has detected that the initial request was for both an emergency and privacy. In the redirection message, e.g., a SIP 380 message, the network node contains an indication that the UE must perform emergency registration if the next request is in the PS domain and also contains a privacy indicator that indicates that privacy is available in the PS domain. The redirection message also contains dialled digits or an indication to the UE to use previously dialled digits. Because privacy is allowed, the preferred route for a second emergency attempt is to use the CS domain with normal procedures since it is not possible to request privacy in an emergency set-up in the CS domain. If the UE does not subscribe to CS access or no CS network is available, the UE can search for another PLMN that utilizes the same technology, perform emergency registration to the other PLMN and send an request with a request for emergency and privacy.

In both of the preceding embodiments, an indicator is sent in the SIP response message to indicate that privacy needs to be invoked or that privacy should be overridden. This indicator can be provided in several ways. In at least one embodiment, the indicator is included in a body (part) with the MIME type message/sipfrag or message/sip. Since the Privacy header field can take a number of values, it is advantageous to use the granularity of the Privacy header field for indicating the type of additional procedures that needs to be performed at the UE. Also, non-privacy-related additional procedures may also be indicated by means of e.g. other SIP header field. As an example of privacy-related additional procedures, the body (part) could include the following for “caller ID needs to be withheld”:

Privacy: id

or the following for “caller ID needs to be presented”:

Privacy: none

In this embodiment the UE needs to support multipart body (part) handling and the network will not include a sipfrag body (part) for other reasons in a SIP response that indicates an earlier SIP request is in fact an emergency request, and the SIP response further includes a P-Asserted-identity header field set to an address of a network node, wherein the Proxy-CSCF is an example of such a network node. The UE, when selecting the:
PS domain for the subsequent request, will include content of the body (part) with the MIME type message/sipfrag or message/sip in the subsequent request;
CS domain for the subsequent request, will initiate the procedures involving the sending of a SETUP request (as opposed to the procedures involving the sending of an EMERGENCY SETUP request).

If UE 102 is able to support multipart body (part) MIME type (e.g. multipart/mixed) and MIME type message/sipfrag or MIME type message/sip, the UE can indicate this in the Accept header field of the first SIP request. The network node responding to the first SIP request with the SIP 380 response will only include MIME type message/sipfrag or message/sip in the SIP 380 response if the first SIP request's Accept header field indicated support for multipart body (part) MIME type (e.g. multipart/mixed) and MIME type message/sipfrag or MIME type message/sip.

As an alternative to including support for multipart body (part) MIME type (e.g. multipart/mixed) and MIME type message/sipfrag or MIME type message/sip in the first SIP request, in at least one embodiment, UE 102 can provide another indicator (e.g. in the first SIP request or a prior SIP REGISTER request). The P-CSCF 112 responding to the first SIP request with the SIP 380 response may only include MIME type message/sipfrag or message/sip in the SIP 380 response if UE 102 provided this other indicator and the network node received the other indicator or an equivalent indicator. In at least one embodiment, the indicator indicating “caller ID needs to be withheld” or “caller ID needs to be presented” are otherwise encoded within the SIP 380 response message or within the XML body included within the SIP 380 response message. Upon detecting the otherwise encoded indicator, UE 102, when selecting the:
PS domain for the subsequent request, will include either “Privacy: id” or “Privacy: none” in the subsequent request, depending on what the indicator indicates;
CS domain for the subsequent request, will initiate the procedures involving the sending of a SETUP request (as opposed to the procedures involving the sending of an EMERGENCY SETUP request).

In at least one embodiment, the indicator is included in a body (part) with a MIME type different from message/sipfrag or message/sip. However, the body (part) contains, for example for privacy-related additional procedures, the following for “caller ID needs to be withheld”:

Privacy: id

or the following for “caller ID needs to be presented”:

Privacy: none

The advantage of using a body (part) with a MIME type different from message/sipfrag or message/sip, yet having the body part contain similar information, is that the P-CSCF can use body parts with MIME type message/sipfrag or message/sip for different purposes. Alternatively, different content encoding may be used e.g. when XML encoding is used:
“<privacy value=”id“>” (e.g. indicating caller ID needs to be removed); or
“<privacy value=“none”>” (e.g. indicating caller ID needs to be provided).
   The above XML encoding or equivalent XML encoding may be detected in a MIME body of the MIME type “application/3gpp-ims+xml”.

IM CN Provides Capabilities on Registering

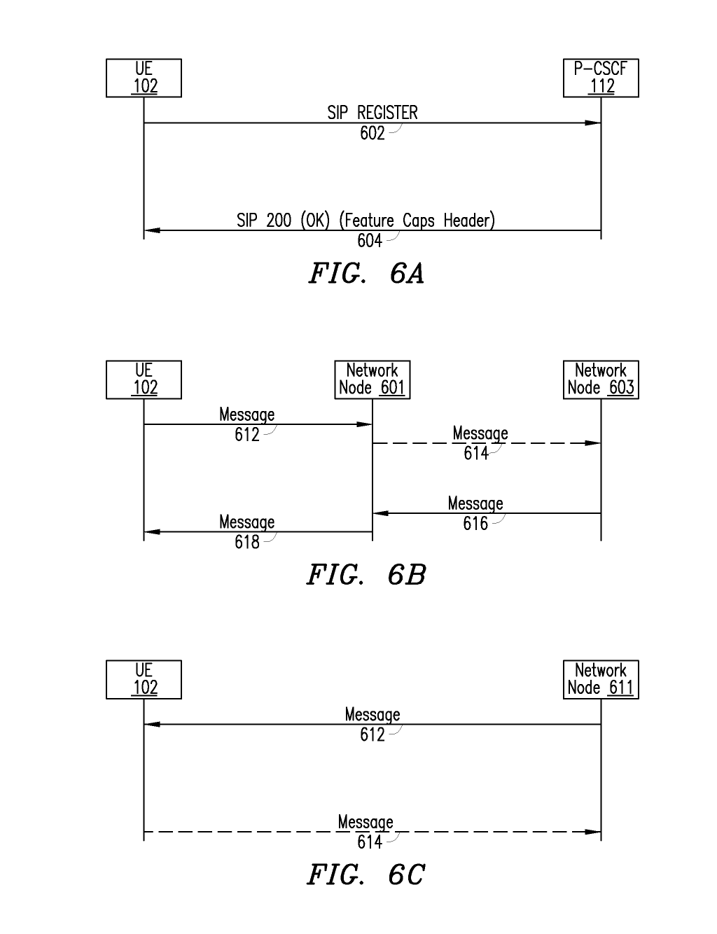

In at least one disclosed embodiment, illustrated in FIG. 6A, when a UE registers with the IM CN network, the appropriate network node, e.g., P-CSCF 112 indicates whether the network allows privacy with requests for emergency service. As shown in this figure, UE 102 sends SIP REGISTER message 602 to P-CSCF 112. P-CSCF 112 uses the information in SIP REGISTER message 602 to bind the IP address of UE 102 with a public user identity and sends a response to the SIP REGISTER message, e.g., SIP 200 (OK) message 604 containing an indication whether privacy in emergency services is allowed. In at least one embodiment, the indicator is provided in a Feature-Caps header field, which is used convey information regarding feature capabilities. In at least one embodiment, the indicator is provided in a different message received at the UE. In at least one embodiment, the indicator is provisioned on the UE along with other network information that is stored, either on the device itself or on a Universal Integrated Circuit Card (UICC) or Universal Subscriber Identification Module (USIM). This type of indicator is provided to the UE prior to handling any SIP 380 (Alternative Service) response.

When UE 102 receives this indication from IM CN 110, UE 102 will retain the information until the UE leaves the network. When the UE receives such an indication of the availability of privacy in an emergency request, the UE can request basic call set-up in the CS domain as long as an appropriate string of digits or alphanumeric characters are available. This is true even after the UE receives a SIP 380 response, regardless of the value of the Contact header field in the SIP 380 response. When the UE does not detect an indication of the availability of privacy in an emergency request, the UE will take into account the value of the Contact header field in the SIP 380 (Alternative Service) response. The value of the Contact header field may cause the UE to attempt an emergency call set-up in the CS domain with an emergency type derived from the received Contact header field value, as discussed elsewhere in this disclosure.

Operator Provisions Service Codes

In at least one embodiment the Operator provisions the UE with a set of service codes, i.e. a set of numeric or alphanumeric strings that each identify a policy and/or functionality that is applied in either the network or UE. An overview of the service codes is described first, followed by details of the provisioning. The service codes can be provisioned in UE 102 or in a UICC card associated with UE 102. Once provisioned, when the UE sends a message to either a CS network or a PS network, the message containing an alphanumeric string, the UE first analyses the string, e.g. the URI in the Request URI for SIP messages, and determines if any of the provisioned service codes have been pre- or post-appended to the alphanumeric string. When a service code is detected, the UE takes appropriate action either by executing specific functionality in the UE or by sending the message to the network with an indication that specific functionality is required. In at least one embodiment, the UE is provisioned with a service code having a value of ‘141’, which in this example means withhold the calling identity. If ‘141911’ is the digit string to be sent to the network, UE 102 recognizes the 141 service code and inserts a header into an outgoing SIP message, e.g. any of SIP initial requests 202, 302, 402, 502; the header signals to the network to withhold the From Header and Contact Header from being provided to the destination identified in the URI in the Request URI. The UE also recognises that the digits 911 are for an emergency call, so the UE would make an identified emergency call using emergency procedures.

The service codes can be provisioned by either broadcast or point-to-point mechanisms and can be provided in response to a request from UE 102 or pushed to the UE without a request by a network node. Point-to-Point mechanisms include but are not limited to using Open Mobile Alliance Device Management (OMA DM), Short Message Service (SMS) Over the Air (OTA) commands to Universal Integrated Circuit Card (UICC)/evolved UICC (eUICC), extensions to Non-Access Stratum (NAS) or session management messages. Some examples of this provisioning are now provided.

An embodiment of provisioning service codes to UE 102 is illustrated in FIG. 6B. UE 102 sends message 612 to first network node 601. First network node 601 can be, but is not limited to an MSC, MSC Server, SGSN, GGSN, P-GW, OMA DM server, or Over the Air activation Server. Message 612 that UE 102 sends can be, but is not limited to, any of an Attach, Location Update, Routing Area Update, Short Message Origination, USSD origination, SIP Register, SIP Subscribe, an OMA message, Session Management Message (e.g. Activate PDP Context request), and an EPS Session Management Message. Message 612 can include one or more of:
An indication that UE 102 supports Service code Updates,
An indication that UE 102 requires a list of Service codes, and
Location information.
   The indications can be coded as a flag, token, code point, an indicator in an information element, a Feature tag, a SIP header field value, or a body (part); the body part can include XML or be a typed message/sip or message/sipfrag.

In return, UE 102 receives message 618, which can be, but is not limited to, an Attach Accept, Location Update Accept, Routing Area Update Accept, Short Message, USSD message, SIP 200 OK, SIP NOTIFY, an OMA message Session Management Message (e.g. Activate PDP Context request), and an EPS Session Management Message. In at least one embodiment, message 618 contains a list of service codes that has been added to the format of the associated message. In this embodiment, UE 102 stores the service codes until one of the following occurs: UE 102 receives another set of service codes, is turned off, or registers on a new PLMN. If first network node 601 determines either that first network node 601 is unable to provide a list of service codes or that service codes are not applicable in the present location of UE 102, then network node 601 can send message 618 without service codes or send message 618 with service codes but with no digit string associated with the service code, e.g., service code “withhold CLI” shall be indicated but no alphanumeric string shall be sent. In at least one embodiment, prior to sending message 618 to UE 102, first network node 601 sends message 614 to second network node 603 to request service codes, where second network node 603 can be, but is not limited to a GGSN, P-GW, OMA DM server, or Over the Air activation Server. Message 614 can be, but is not limited to, a Short Message Origination, USSD origination, SIP Register, SIP Subscribe, an OMA message, Session Management Massage (e.g. Activate PDP Context request), or an EPS Session Management Message. If second network node 603 is able to provide service codes to first network node 601 as message 616, then first network node 601 is able to provide service codes to UE 102.

In at least one embodiment, illustrated in FIG. 6C, the network provisions UE 102 by pushing the service codes to the UE. In this embodiment, network node 611 sends message 612 to UE 102. Network node 611 can be, but is not limited to an MSC, MSC Server, SGSN, GGSN, P-GW, OMA DM server, or Over the Air activation Server and message 612 can include at least Short Message Termination, USSD Termination, an OMA message, a SIP NOTIFY message, a Session Management Message or an EPS Session Management Message. Message 612 contains a list of service codes for use by UE 102; each code contains an indication of the purpose of that code. After receiving message 612, UE 102 stores the list of service codes and retains the list until further notice. UE 102 can optionally respond with message 614, e.g. to acknowledge receipt of the service codes.

In at least one embodiment, service codes are encoded in the Emergency Number List information element, with the format shown below:

| 8 | 7 | 6 | 5 | 4 | 3 | 2 | 1 | |
|---|---|---|---|---|---|---|---|---|
| Service Number List IEI | | | | | | | | octet 1 |
| Length of Service Number List IE contents | | | | | | | | octet 2 |
| Length of lst Service Number information (Note 1) | | | | | | | | octet 3 |
| Spare | | | Service Number Category | | | | | octet 4 |
| 0 | 0 | 0 | | | | | | |
| Number digit 2 | | | | Number digit 1 | | | | octet 5 |
| | | | | | | | | (Note 2) |
| Number digit 4 | | | | Number digit 3 | | | | octet 6* |
| . | | | | . | | | | . |
| . | | | | . | | | | . |
| . | | | | . | | | | . |
| (Note 3) | | | | | | | | octet j−1* |
| Length of 2nd Service Number information (Note 1) | | | | | | | | octet j* |
| Spare | | | Service Number Category | | | | | octet j+1* |
| 0 | 0 | 0 | | | | | | |
| Number digit 2 | | | | Number digit 1 | | | | octet j+2* |
| | | | | | | | | (Note 2) |
| Number digit 4 | | | | Number digit 3 | | | | octet j+3* |
| . | | | | . | | | | . |
| . | | | | . | | | | . |
| . | | | | . | | | | . |
| (Note 3) | | | | . | | | | octet j+k* |
| | | | | . | | | | |
| | | | | . | | | | |
| . | | | | | | | | . |
| . | | | | | | | | . |
| . | | | | | | | | . |
| Length of xth Service Number information (Note 1) | | | | | | | | octet n* |
| Spare | | | Service Number Category Value | | | | | octet n+1* |
| 0 | 0 | 0 | | | | | | |
| Number digit 2 | | | | Number digit 1 | | | | octet n+2* |
| | | | | | | | | (Note 2) |

| | | |
|---|---|---|
| Number digit 4 | Number digit 3 | octet n+3* |
| . | . | . |
| . | . | . |
| . | . | . |
| (Note 3) | . | octet n+m* |
| | . | |
| | . | |

Service Number Category Value

| Bit | | | | |
|---|---|---|---|---|
| 4 | 3 | 2 | 1 | |
| 0 | 0 | 0 | 0 | CLI Withheld |
| 0 | 0 | 0 | 1 | CLI Withheld override |
| 0 | 0 | 1 | 0 | Location withheld |
| 0 | 0 | 1 | 1 | Location withheld override |

The key concepts in this encoding are that
Service Number category's are defined; and
At category, a digit string is defined.
   When a defined digit string is detected in a destination or called address, the UE knows that the associated functionality as identified by the service number category is to be invoked.

FIG. 7 depicts a block diagram of an embodiment of a communication device 700 operable as a UE, e.g., UE 102, for purposes of the present patent disclosure. A microprocessor 702 providing for the overall control of an embodiment of the UE is operably coupled to a communication subsystem 704 that is capable of operation on multiple bands and in multiple access technologies as necessary. The communication subsystem 704 generally includes one or more receivers 708 and one or more transmitters 714 as well as associated components such as one or more local oscillator (LO) modules 710 and a processing module such as a digital signal processor (DSP) 712. As will be apparent to those skilled in the field of communication, the particular design of communication module 704 may be dependent upon the bands and access technologies with which the mobile device is intended to operate (e.g., CDMA, GSM, WLAN, LTE-A, et cetera). Regardless of the particular design, however, signals received by antenna 706 through appropriate access infrastructure are provided to receiver 708, which may perform such common receiver functions as signal amplification, frequency down conversion, filtering, channel selection, analog-to-digital (A/D) conversion, and the like. Similarly, signals to be transmitted are processed, including modulation and encoding, for example, by DSP 712, and provided to transmitter 714 for digital-to-analog (D/A) conversion, frequency up conversion, filtering, amplification and transmission over the air-radio interface via antenna 716. In at least one embodiment, communication module 704 may be duplicated so that mobile communication device 700 is able to operate on several bands simultaneously and may have the capability to operate using multiple-inputs, multiple-outputs (MIMO). In some implementations of the communication modules (704), the receive antenna (706) and the transmit antenna (716) may be combined into a single apparatus and appropriately coupled to the receiver (708) and the transmitter (714). Some implementations may also include multiple antennae for improved performance using techniques such as diversity.

Microprocessor 702 may also interface with further device subsystems such as auxiliary input/output (I/O) 718, serial port 720, display 722, keyboard/keypad 724, speaker 726, microphone 728, random access memory (RAM) 730 and any other device subsystems, e.g., timer mechanisms, generally labelled as reference numeral 733. To control access, an interface 734 may also be provided in communication with the microprocessor 702 with respect to a removable storage module (Universal/Subscriber Identity Module (U/SIM) or Removable User Identity Module (RUIN)). In one implementation, U/SIM or RUIN interface 734 may be operable with a U/SIM or RUIN card having a number of key configurations 744 and other information 746 such as default content disposition profiles, policy managers, alternative network information, as well as identification and subscriber-related data that may supplement local storage-based information.

Operating system software and applicable service logic software may be embodied in a persistent storage module (i.e., non-volatile storage) such as Flash memory 735. In one implementation, Flash memory 735 may be segregated into different areas, e.g., storage area for computer programs 736 (e.g., service processing logic), as well as data storage regions such as device state 737, address book 739, other personal information manager (PIM) data 741, and other data storage areas generally labelled as reference numeral 743. In addition, Privacy/Emergency module 748 is provided for maintaining privacy applied to communication caused by an emergency, as set forth in detail for one or more embodiments hereinabove.

In the above-description of various embodiments of the present disclosure, it is to be understood that the terminology used herein is for the purpose of describing particular embodiments only and is not intended to be limiting of the claims. At least some example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions (e.g., stored in computer-readable media) that are performed by one or more computer circuits. Such computer program instructions may be provided to a processor circuit of a general-purpose computer circuit, special purpose computer circuit, and/or other programmable data processing circuit to practice one or more embodiments of the present patent disclosure. By way of illustration, at least one or more embodiments of the privacy maintenance logic during emergency communications may be effectuated in a UE such as shown in FIG. 7, taking reference to one or more message flow embodiments shown in FIGS. 2-6, attached herewith.

Tangible, non-transitory computer-readable media may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, and the like. The computer program instructions may also be loaded onto or otherwise downloaded to a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software including firmware, etc.

Further, in at least some additional or alternative implementations, the functions/acts described in the blocks may occur out of the order shown in the block diagrams or flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. It should therefore be appreciated that not all embodiments need to have all of the features described in detail hereinabove and any combination and/or sub-combination thereof may be implemented together in an example embodiment for practicing the teachings herein.

It is believed that the operation and construction of the embodiments of the present patent application will be apparent from the Detailed Description set forth above. While example embodiments have been shown and described, it should be readily understood that various changes and modifications could be made therein without departing from the scope of the present disclosure as set forth in the following claims.

What is claimed is:

1. A method operable at a User Equipment (UE) comprising:
sending a first SIP message to a network, the first SIP message requesting a first service comprising at least privacy;
responsive to sending the first SIP message, receiving at the UE a SIP response message, the SIP response message including a Contact header field with an indicator as a value, the indicator based on the first service; and
sending a second SIP message with the indicator, the second SIP message requesting a second service.

2. The method according to claim 1 wherein the UE is unable to detect the first service.

3. The method according to claim 1 wherein the network comprises a P-CSCF.

4. The method according to claim 1 wherein the first service further comprises an emergency.

5. The method according to claim 1 wherein the first service further comprises priority.

6. The method according to claim 1 wherein the first SIP message receives preferential treatment.

7. The method according to claim 1 wherein the indicator is a first URN.

8. The method according to claim 7 herein the first SIP message comprises a Request-URI set to a URI and a Privacy header field set to a value.

9. The method according to claim 8 wherein the URI comprises a second URN, the second URN different from the first URN.

10. The method according to claim 9 wherein the second URN comprises “privacy”.

11. A method operable at a network node comprising:
receiving a SIP message from a User Equipment (UE), the SIP message requesting a service;
responsive to the receiving, sending a SIP response message, the SIP response message including a Contact header field with an indicator as a value, the indicator based on the service, the indicator comprising an indication of privacy and “sos”.

12. The method according to claim 11 wherein the service further comprises an emergency.

13. The method according to claim 11 wherein the service further comprises priority.

14. The method according to claim 11 wherein the received SIP message has received preferential treatment.

15. The method according to claim 11, wherein the indicator is a first URN.

16. The method according to claim 15, wherein the SIP message requesting a service comprises a Request-URI set to a URI and a Privacy header field set to a value.

17. The method according to claim 16, wherein the URI comprises second URN, the second URN different from the first URN.

18. The method according to claim 17, wherein the second URN comprises “privacy”.

19. A user equipment (UE) comprising:
a processor operably connected to a memory and to a communications subsystem; and
instructions stored in the memory and operable to be performed by the processor to perform the actions of
sending a first SIP message to a network, the first SIP message requesting a first service comprising at least privacy;
responsive to sending the first SIP message, receiving at the UE a SIP response message, the SIP response message including a Contact header field with an indicator as a value, the indicator based on the first service; and
sending a second SIP message with the indicator, the second SIP message requesting a second service.
